(19) United States
(12) Patent Application Publication
(10) Pub. No.: US 2009/0304073 A1
(43) Pub. Date: Dec. 10, 2009

(54) Systems and Methods for the Bandwidth Efficient Processing of Data

(76) Inventors: Mohammad Usman, Mission Viejo, CA (US); Amjad Luna, Irvine, CA (US); Asfandyar Khan, Tustin, CA (US)

Correspondence Address: PATENTMETRIX, 14252 CULVER DR. BOX 914, IRVINE, CA, 92604, US

(21) Appl. No.: 12/134,283

(22) Filed: Jun. 6, 2008

(51) Int. Cl. H04N 7/26

(52) U.S. Cl. 375/240.03; 375/E07.126

(57) ABSTRACT

The present invention is directed towards an improved method and system for compressing video images. In one embodiment, the system of present invention performs compression of digital video by converting pixels from the red, green and blue (RGB) color space to the luminance color, blue color difference and red color difference (YCbCr) color space, quantizing each Y, Cb, and Cr value into a specified number of bits each, and rearranging the Y, Cb, and Cr values into Cb, Cr, Y to create a word. The system of present invention further involves computing a pair of distinct characteristic code values for each word, which are coded and concatenated to produce the final bitstream.

### FIELD OF THE INVENTION

The present invention relates generally to image processing, and more specifically, to techniques for bandwidth efficient compression of images.

### BACKGROUND OF THE INVENTION

Images can be stored electronically in digital form as matrices of quantized values. Each matrix is a two-dimensional grid of individual picture elements or “pixels.” Each pixel has an integer value representing a color or grayscale tonal value on an integer-based gradient scale. For example, a single 16-bit pixel value represents one color picked from a palette consisting of 65,536 individual colors. The pixel values for each image are stored into a file representing the image rendered at a set dimension, such as 640×480 pixels.

In raw uncompressed form, the size of a digital image file increases dramatically with the size of the color palette and image dimensions. A richer color palette implies higher resolution, and requires more integer values or pixels. Similarly, a larger dimensioned image requires an increased number of pixels. If the images are part of a moving sequence of images, as in video, the storage requirements are multiplied by the number of frames. Further, the bandwidth requirements to transmit and display a video sequence are much higher than with images. It is often desirable to utilize data compression to reduce data storage and bandwidth requirements. Compression algorithms take advantage of redundancy in the image and the peculiarities of the human vision system to compress the size of a digital image file. The Moving Picture Experts Group (MPEG) file format is presently a commonly used format for compressing digital video. MPEG algorithms compress data to form smaller bit sizes that can be easily transmitted and then decompressed. MPEG achieves its high compression rate by storing only the changes from one frame to another, instead of each entire frame. The video information is then encoded using a technique called Discrete Cosine Transform (DCT).

Currently, digital images and video are being increasingly exchanged between interconnected networks of computer systems, including over the Internet, as well as between other computing devices such as personal data assistants (PDAs) and cellular phones. Conventionally, the ability to exchange data, including digital video, over a network, is limited by the network bandwidth available to each device. The bandwidth is affected by the capability of the network itself as well as by the means by which each client is interconnected. A slow modem connection, for instance, is a form of low bandwidth connection that can restrict the ability of an individual client to exchange data. A lower bandwidth means longer download times for larger file sizes. Low bandwidth is particularly problematic when receiving digital video as content embedded, for instance, in Web pages.

One solution to the low bandwidth problem is to recompress video that is already stored in a compressed format, such as the MPEG file format, to further conserve on space and bandwidth requirements. The MPEG file format, however, is a video compression file format that is mostly used in a “lossy” version, that is, a version that loses some amount of data upon compression. Therefore, successive recompressions will result in additional data loss and in the formation of visual artifacts which deteriorate the perceptual quality of a video image.

Therefore, there is a need for an approach to compressing video that provides adequate compression to reduce the bandwidth requirements of transmitting video, while minimizing the incidence of artifacts in compressed video images at the same time, so that such data can be efficiently transmitted and stored on the available mass storage devices.

### SUMMARY OF THE INVENTION

The aforementioned and other embodiments of the present shall be described in greater depth in the drawings and detailed description provided below. In one embodiment, the present invention is a method for compressing video data, the method comprising, for each pixel converting pixel data from the RGB color space to the YCbCr color space, quantizing the Y, Cb, and Cr values to generate a specified number of bits for each Y, Cb and Cr value, rearranging and concatenating the bits of quantized Y, Cb, and Cr values in Cb, Cr, Y format to create a word, and creating a bitstream using data derived from said word.

The step of creating a bitstream using data derived from said word comprises the steps of determining a first characteristic code value using the word, determining a second characteristic code value using the first characteristic code value, and concatenating said first and second characteristic code values to generate a coded bitstream. The first characteristic code value represents the difference between two successive words. The second characteristic code value represents the number of consecutive first characteristic code values having the same value.

Optionally, the method further comprises the step of determining a first characteristic code value by classifying the first characteristic code value into a plurality of code length categories. The number of code length categories equals at least four. The code length categories are selected from the group consisting of 4 bits, 9 bits, 15 bits, and 21 bits. The method further comprises the step of setting a value for a first set of bits in the first characteristic code value based on said determination step. The last bit of the first characteristic code value specifies the sign of the first characteristic code value.

In another embodiment, the method for decoding compressed video data comprises extracting first characteristic code values and second characteristic code values from a coded bitstream, determining binary words representing pixels from the first and second characteristic code values extracted in the previous step, rearranging the binary words from a Cb,Cr,Y format into a Y,Cb,Cr format, subjecting the Y, Cb and Cr values for each word to inverse quantization, and converting the inverse quantized Y, Cb and Cr values from a YCbCr color space into a RGB color space. One of ordinary skill in the art would appreciate that the decoding process comprises the steps of encoding process performed in reverse.

In another embodiment, the system for compressing video data comprise a color converter for converting pixel data from a RGB color space to a YCbCr color space, quantization elements for quantizing each of the Y, Cb, and Cr values to generate a specified number of bits for each Y, Cb and Cr value and means for rearranging and concatenating the bits of quantized Y, Cb, and Cr values in Cb, Cr, Y format to create a word, and means for generating a coded bitstream based upon said word. The system further comprises a switch, which may be configured to select either one or a combination encoding techniques for compressing video data.

The system further comprises a means for generating a first characteristic code value wherein said first characteristic code value represents the difference between two successive words. The system further comprises a means for generating a second characteristic code value wherein the second characteristic code value represents the number of consecutive first characteristic code values having the same value.

In another embodiment, the present invention is directed to a method and system for compressing video data, the method comprising, for each pixel converting pixel data from the a first color space to a second color space having at least three value types, quantizing the three value types to generate a specified number of bits for each value type, rearranging and concatenating the bits of quantized value types in a different format to create a word, and creating a bitstream using data derived from said word.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 is a flow chart illustrating steps of the encoding method of the present invention;

FIG. 2 is a table illustrating how delta level values are computed and encoded;

FIG. 3 depicts a table for computing and encoding the value of RUN;

FIG. 4 is a flow chart illustrating the steps in computing the RUN code;

FIG. 5 illustrates one example of the encoding method of the present invention;

FIG. 6 is a block diagram depicting one embodiment of the architecture of the encoder of the present invention;

FIG. 7 is a block diagram depicting one embodiment of the architecture of the encoder of the present invention;

FIG. 8 is a table comparing the compression statistics achieved with different quantization formats, as used in the present invention.

### DETAILED DESCRIPTION OF THE INVENTION

The present invention presents improved methods and systems for compressing video images. In one embodiment, the present invention is directed towards a method for compressing digital video by converting pixel data from the red, green and blue (RGB) color space to the luminance color, blue color difference and red color difference (YCbCr) color space, quantizing each Y, Cb, and Cr value into a specified number of bits each, and rearranging the Y, Cb, and Cr values into Cb, Cr, Y to create a word. It should be appreciated that, by concatenating the three pixels (Y,Cb,Cr) and treating them as one piece of data, the data processing system does not have to process each plane separately and therefore need only perform a single read/write as opposed to three reads/writes.

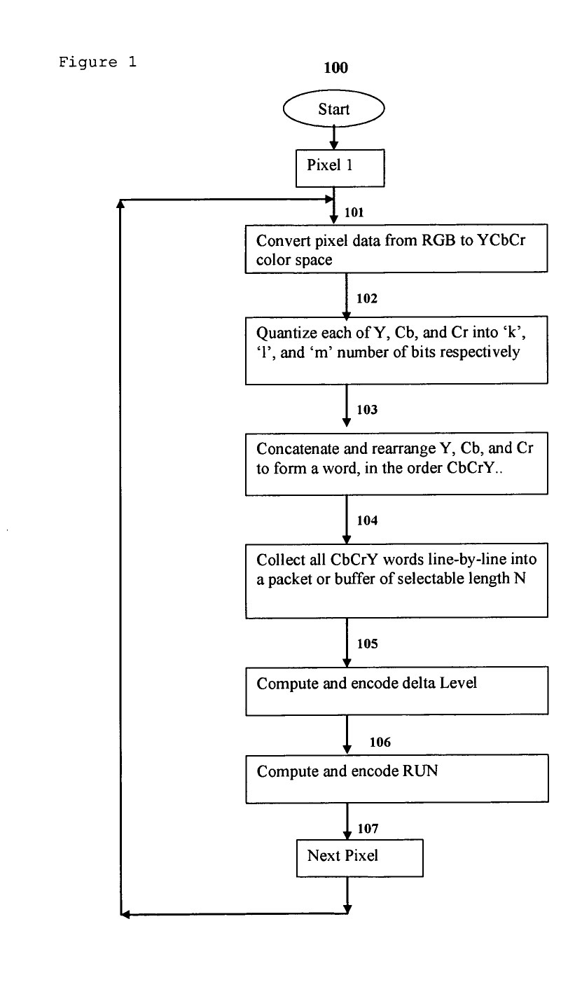

FIG. 1 illustrates, by means of a flow chart, steps comprising the encoding method of the present invention. Referring to FIG. 1, the first step 101 of the encoding process involves converting the pixel data from the image from RGB color space to YCbCr color space. The process of color space conversion is well known in the art, and is performed by applying the following set of formulae:

Y=0.299R+0.587G+0.114B (1)

Cb=0.564(B−Y) (2)

Cr=0.713(R−Y) (3)

Equations (2) and (3) can be expanded so that the Cb and Cr color signals are entirely in terms of the R, G and B color signals:

Cb=−0.169R−0.331G+0.5B (4)

Cr=0.5R−0.419G−0.081B (5)

In the next step 102, each of the Y, Cb, and Cr pixel values obtained as above, is quantized into ‘k’, ‘l’, and ‘m’ number of bits respectively. The steps involved in the quantization process are well known in the art. In one embodiment of the present invention, the value of each of ‘k’, ‘l’, and ‘m’ is 6. That is, Y, Cb, and Cr values are quantized into 6 bit values each.

In the next step 103, the quantized Y, Cb, and Cr values are concatenated together to form a word, in the order CbCrY. That is, the Cb values occupy the most significant bit positions, Y values are placed in the least significant bit positions, and Cr values are placed in the middle. In the embodiment where each of k, l, and m is 6 bits, the length of the resulting concatenated word (k+l+m) is 18 bits. In this manner, each pixel is represented by an 18-bit word.

In the following step, each of the CbCrY words for pixel data are collected line-by-line into a packet or buffer of selectable length N, such that the following arrangement of ‘N’ number of words is obtained:

(C_{b}CᵣY)₁(C_{b}CᵣY)₂ . . . (C_{b}CᵣY)_{N}

This is depicted in step 104 of the flow chart. Each (k+l+m)-bit word CbCrY in the packet is characterized by a distinct pair of values—delta level (ΔLEVEL) and ‘RUN’. In the following steps 105 and 106, the values of delta level and RUN are respectively computed and encoded. The process of computing and encoding delta level and RUN values is explained in detail later in this document.

The abovementioned steps 101 through 106 are repeated until data for all the pixels are encoded. The final coded bitstream for pixel data comprises, for each word representing a pixel, the code for delta level followed by the code value for RUN.

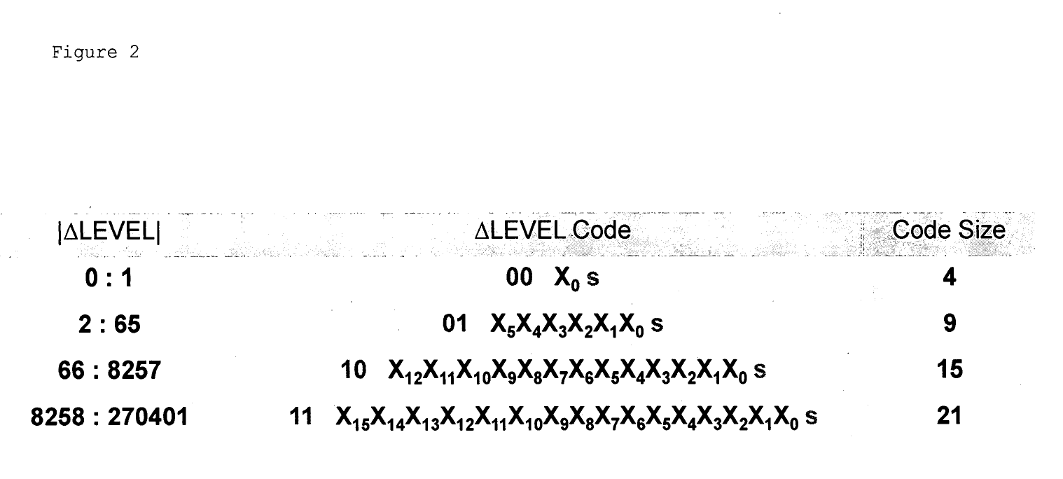

FIG. 2 illustrates by means of a table how delta level values are computed and encoded. The delta level value measures the difference between two words and then encodes that difference. Since the difference between words encoded as delta level is transmitted in the final coded bitstream, therefore for maximum compression it would be preferable if this difference is small, as coding a smaller difference between words in binary would require fewer number of bits. In order to achieve a smaller difference and therefore use fewer bits, the quantized Y, Cb, and Cr values are arranged in the order CbCrY when concatenated together to form a word, as mentioned previously with reference to step 103 of FIG. 1. The reason for this particular arrangement at the time of creating a word to represent a pixel is that the variance between Cb values tends to be small, while the variance between Y values tends to be great. Therefore, when the difference between words is calculated to determine delta Level, having the Y values in least significant bit positions while the Cb values are in the most significant bit positions, yields a smaller numerical difference which can be encoded with fewer bits. Thus, this particular rearrangement of bits provides an added advantage in the compression method of the present invention.

Referring to FIG. 2, a codeword for ΔLEVEL can have one of four possible lengths—4, 9, 15 or 21 bits, depending upon whether the value of delta level falls within the range 0 to 1 (0:1), or 2 to 65 (2:65), or 66 to 8257 (66:8257), or 8258 to 270401 (8258:270401), respectively. The first two bits of the delta level code specify the code-length, as shown in ‘ΔLEVEL code’ column entries in the table of FIG. 2. Thus, if the value of delta level falls within the range 0 to 1 (0:1), the initial two bits are set as ‘00’ and the total number of bits in the ΔLEVEL code would be 4. Similarly, the ΔLEVEL code length would be 9 bits, 15 bits or 21 bits, if the values of initial two bits are ‘01’, ‘10’, and ‘11’ respectively.

The last bit of the delta level code specifies the sign of ΔLEVEL, as shown in ΔLEVEL code entries in the table of FIG. 2. The rest of the bits of the delta level code denote absolute value of ΔLEVEL.

The aforementioned code structure for delta level has two advantages. Firstly, this code allows for transmitting the difference between word values of pixels, rather than the entire word value. Thus, for example if an image has a lot of redundancy—which implies a number of similarly valued pixels, the first word will be long as it represents the absolute pixel value, but the following delta level values will be small, as they represent the difference between successive words or pixel values. Secondly, the delta level code structure of the present invention enables delta levels to be represented by codewords of predictable or known lengths. This is because, although the absolute value of delta level may vary, depending upon the numerical difference it represents, the total length of the codeword is known and indicated by the values of first two bits. This feature is particularly important in parallel processing environments, wherein the ability to concurrently process multiple words simultaneously is required. During parallel processing, if the codewords are of variable length, it cannot be determined where one word ends and the other begins, and this poses problems. The code structure of present invention also generates variable length words; however the coding scheme lets the system predict the length of each word through the first two bits of that word. Therefore, the pointer can be simply moved ahead by the length indicated by code size when performing parallel processing.

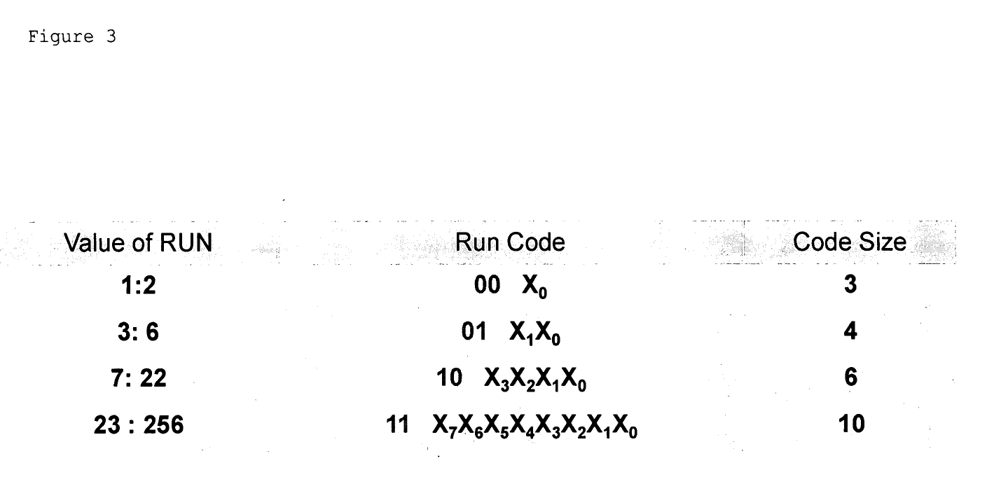

FIG. 3 depicts a table for computing and encoding the value of RUN for a given pixel. The RUN value provides further compression for pixel data and corresponds to the number of consecutive delta levels with the same value. The RUN value is encoded in the same way as delta level. As can be seen from the table of FIG. 3, the RUN value may lie in one of the four ranges—0 to 1 (0:1), 3 to 6 (3:6), 7 to 22 (7:22) and 23 to 256 (23:256), and accordingly, can have one of four possible bit lengths. The first two bits of the RUN code specify the code length. These bits are highlighted in red in ‘RUN code’ column entries in the table of FIG. 3. Thus, if the value of RUN falls within the range 0 to 1 (0:1), the initial two bits are set as ‘00’ and the total number of bits in the RUN code would be 3. Similarly, the RUN code length would be 4 bits, 6 bits or 10 bits, if the values of initial two bits are ‘01’, ‘10’, and ‘11’ respectively. The rest of the bits in the RUN code denote the absolute value of RUN.

The code structure of RUN enables deriving codewords of predictable or known lengths. As with the code structure of delta level, the RUN code structure also offers the added advantage in parallel processing, as the total length of the codeword is known and indicated by the values of first two bits in the code.

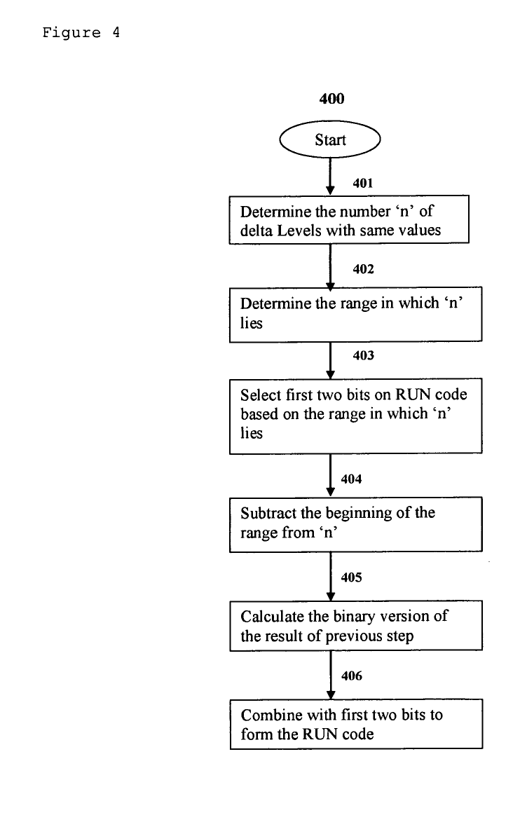

FIG. 4 illustrates the steps in computing the RUN code by means of a flowchart. In order to calculate the absolute RUN value, the number of delta levels with same values is first determined, as shown in step 401. This number is designated as ‘n’. Then in step 402, the range in which this number ‘n’ lies is ascertained. The first two bits of the RUN code are selected based on which of the four ranges the number lies, the four possible ranges being—0 to 1 (0:1), 3 to 6 (3:6), 7 to 22 (7:22) and 23 to 256 (23:256). This is shown in step 403. In the next step 404, the beginning of the range is subtracted from ‘n’. The binary version of the resulting value is then calculated, as in step 405 and concatenated 406 with the first two bits to form the RUN code.

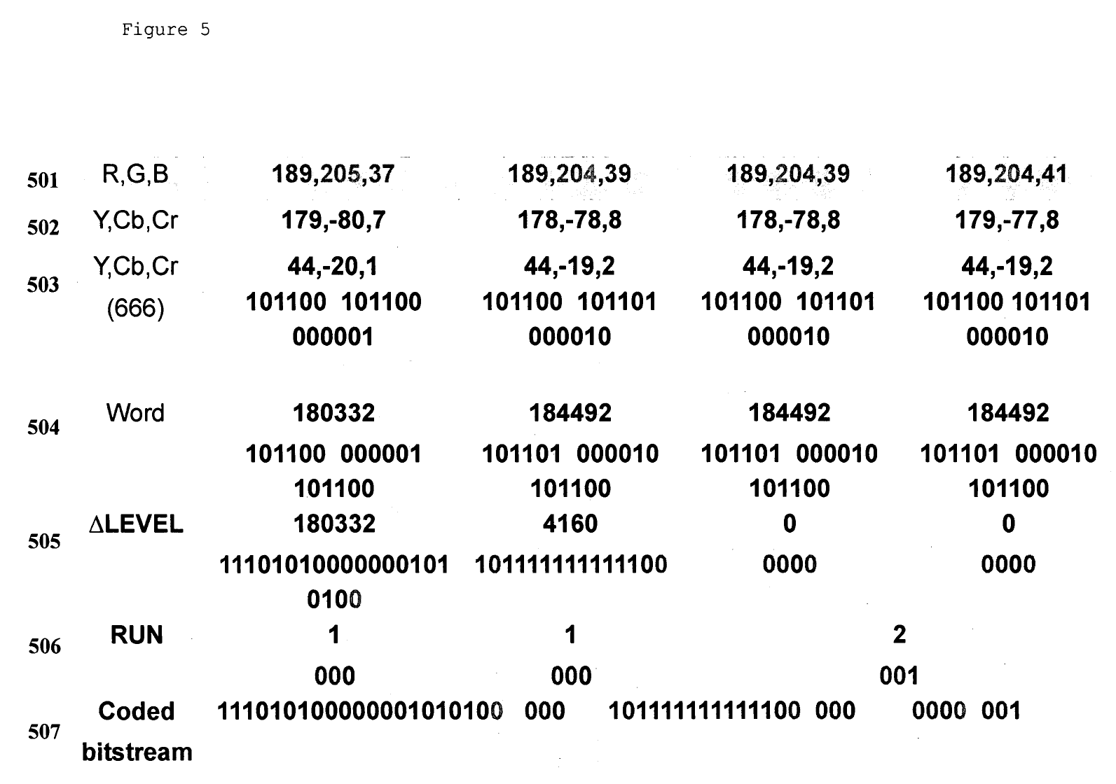

FIG. 5 illustrates in a table, the encoding method of the present invention with the help of an example. In this example, four pixels are considered with the following (R,G,B) values, as shown in row 501 of the table of FIG. 5:

| | | | |
|---|---|---|---|
| 189,205,37 | 189,204,39 | 189,204,39 | 189,204,41 |

In accordance with the encoding method of the present invention, pixel data is first converted from R,G,B space to Y,Cb,Cr color space. Accordingly, as shown in row 502, the following corresponding (Y,Cb,Cr) values of the four pixels are obtained (referring to, and making use of equations (1) through (5) mentioned previously):

| | | | |
|---|---|---|---|
| 179, −80.7 | 178, −78.8 | 178, −78.8 | 179, −77.8 |

Thereafter, each of Y, Cb, and Cr values are quantized into 6 bit values each. The quantized Y,Cb,Cr values are:

| | | | |
|---|---|---|---|
| 44, −20.1 | 44, −19.2 | 44, −19.2 | 44, −19.2 |

The corresponding binary values for the quantized Y,Cb,Cr values are shown in the row 503 of the table of FIG. 5.

Next, the Y, Cb, and Cr values are rearranged into Cb, Cr, Y to create an 18-bit word. The corresponding decimal values of the 18-bit binary words for the four pixels are:

| | | | |
|---|---|---|---|
| 180332 | 184492 | 184492 | 184492 |

The aforementioned decimal values along with their corresponding binary values for pixels are given in row 504.

Next, the delta level values are computed, which measure the difference between two words. For computing delta Level for a word, first the range within which the word falls is determined. In this example, the first word is “180332”, as explained above. This word falls into the range 8258:270401. Therefore, the first two bits of the delta level code will be set as “11” and then the next set of bits will be the binary version of the difference between the word and the beginning of the range (180332-8258). The final bit of the code denotes the sign of delta level. The 21-bit code for the first word “180332” is shown in the row 505 of the table of FIG. 5.

For the next word, the difference between this word and the previous word is “4160”, and it falls within the range 66:8257. On the basis of this information, all the bits of the binary code for the second word are determined. In the same manner, delta level codes for the other two words are also computed, and are shown in the row 505 of FIG. 5.

Thereafter the RUN code is computed, which establishes the number of consecutive delta levels with the same value. In the illustrated example, the value of RUN for the first two words is 1 each, while that for the last two words is 2, as shown row 506 of FIG. 5. The binary code for run is computed as described in the flowchart of FIG. 4. Finally the coded bitstream is generated, as specified in row 507 of FIG. 5. The coded bitstream comprises the delta Level value in binary followed by the RUN value in binary for each pixel word in succession.

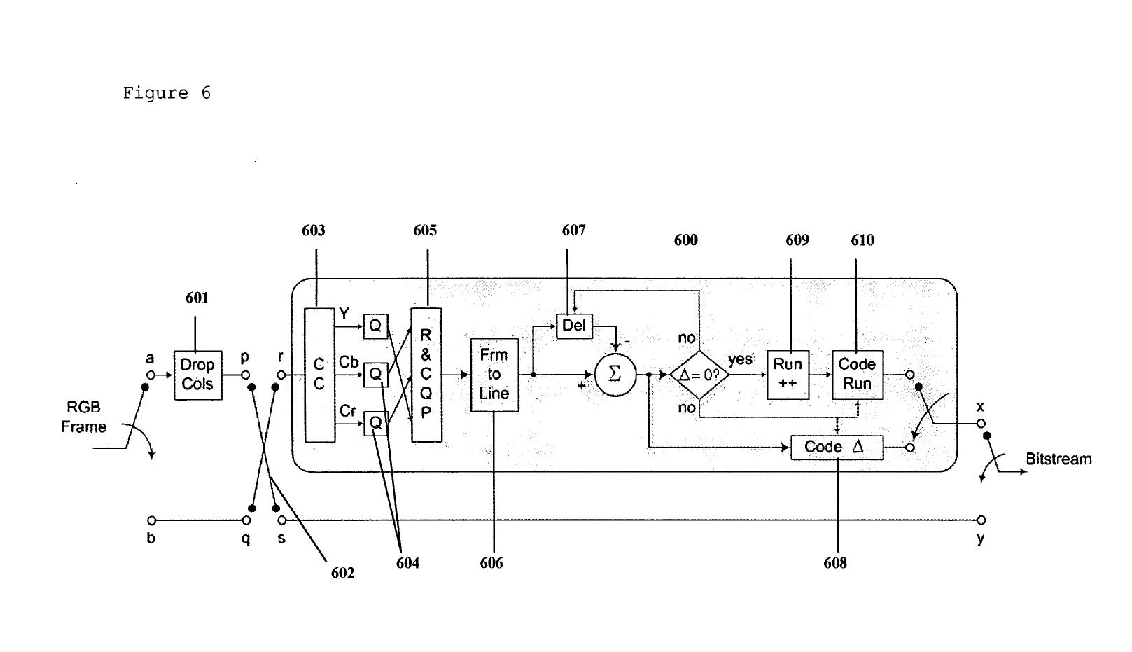

FIG. 6 shows the circuit embodiment of the encoding method of the present invention. The architecture comprises the encoder block diagram 600 preceded by a block 601 which implements the “drop columns’ method of compression. The “drop columns’ method is a standard approach to compressing digital images and involves dropping columns of pixels from the areas of redundancy in the original image to enable transmitting less information. On the receiver side, the dropped values are replaced with some derived number such as an average of surrounding pixel values or a copy of a nearby pixel value, thereby scaling up and obtaining the original image size. The architecture of the encoder is designed such that the drop columns mode may optionally be used with the novel encoding process of the present invention. For this purpose, the encoder is provided with a switch 602. As shown in FIG. 6, Switch positions can be configured to support the following four modes:
Switch position ‘aprx’ enables Scaled Encode (Drop Columns Plus Encoding)
Switch position ‘apsy’ enables Scaled Bypass (Drop Columns Only)
Switch position ‘bqrx’ enables Unscaled Encode (Encoding Only)
Switch position ‘bqsy’ enables All Bypass (Bypass all)

To carry out the encoding process of the present invention, pixel data is first converted from (R,G,B) color space to (Y,Cb,Cr) color space. This step is carried out by the color converter 603. Next, the (Y,Cb,Cr) data is quantized by quantization elements 604. The quantized pixels are then rearranged and concatenated by the R & CQP (R&CQP stands for Reorder & Concatenate Quantized Pixels) block 605. The pixel data from video frames is then transferred to line by the block 606 for further processing. After introducing a delay via the element 607, delta level, which is the difference between two words, is calculated and coded by the block 608. Depending on the value of delta Level, RUN value is computed and coded by blocks 609 and 610. The coded delta Level and RUN values are then used to generate the bitstream.

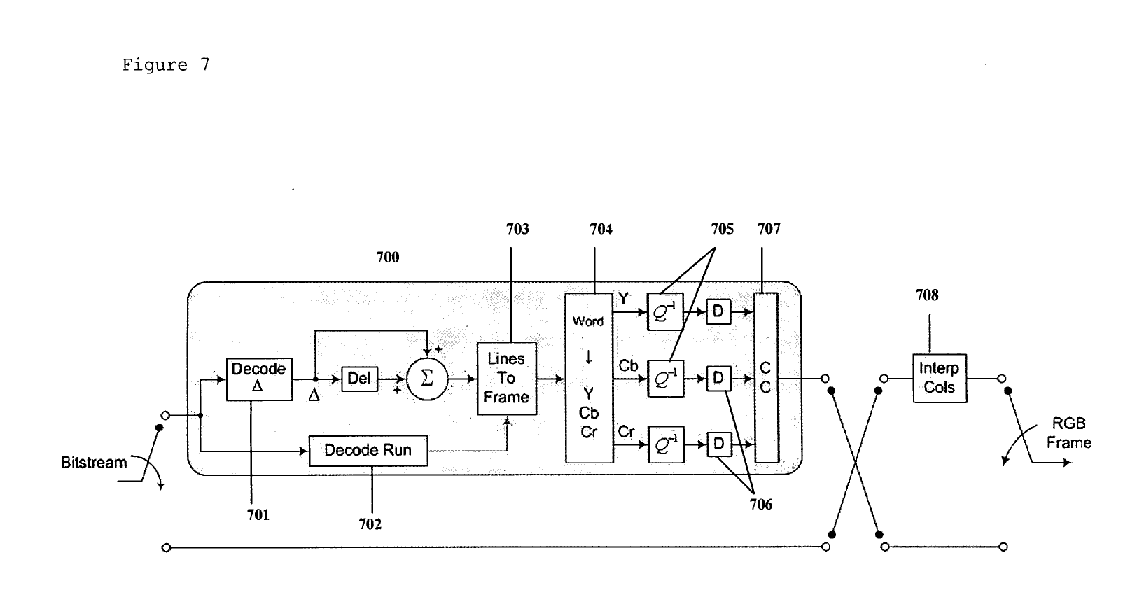

FIG. 7 shows the architecture of the decoder of the present invention. Referring to FIG. 7, when the coded bitstream is input at the decoder 700, then delta level and RUN values are first decoded by the elements 701 and 702 respectively. From these two values, binary words representing pixels in (Cb,Cr,Y) format are derived, and line data is converted to video frames by the block 703. The words are then arranged in (Y,Cb,Cr) format by block 704. Y, Cb and Cr values are then individually subjected to inverse quantization using elements 705 and dithering through elements 706 to yield the original Y, Cb and Cr values for pixels. Thereafter (Y,Cb,Cr) pixel data is converted into (R,G,B) color space by the color converter 707. The decoder block is followed by an ‘Interpolate columns’ block 708, which interpolates any columns dropped during the encoding process.

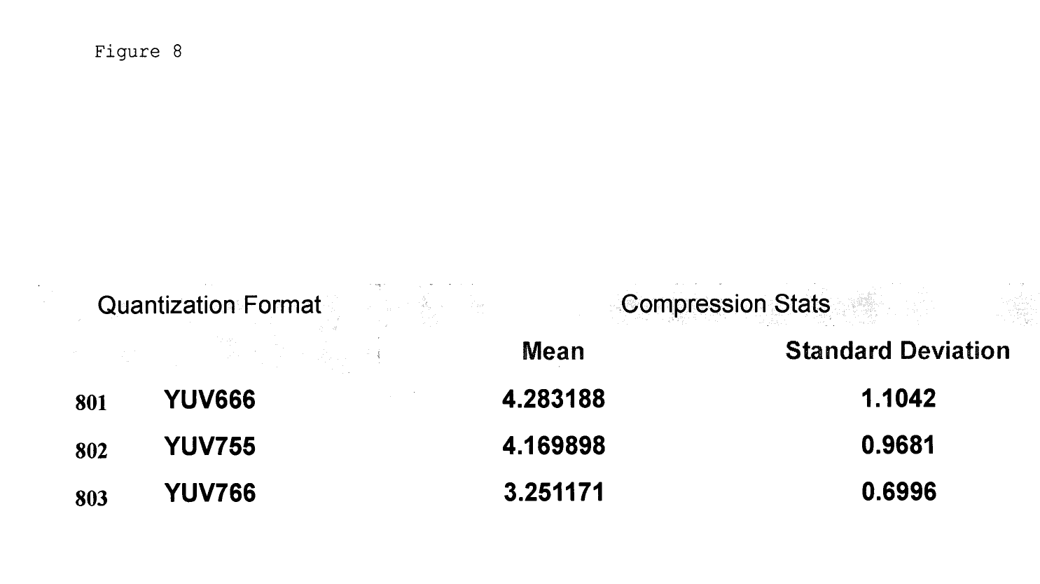

The encoding method of the present invention has been described with an exemplary quantization format wherein pixel data is converted from (R,G,B) color space to (Y,Cb,Cr) color space and each of Y, Cb and Cr values are quantized into 6 bits binary values. However, one of ordinary skill in the art would appreciate that the Y, Cb and Cr values may be quantized into binary values of any number of bits. Different levels of compression can be achieved by varying the quantization format, that is, by varying the number of bits used to represent the Y, Cb and Cr values. FIG. 8 is a table detailing the comparison of compression statistics achieved with different quantization formats. These compression statistics are based on a sequence of 22 images. As can be seen from FIG. 8, a YUV format with 6 bits 801 each yields the highest mean and standard deviation, while a quantization format of YUV766 803 yields the lowest mean and standard deviation. YUV755 802 yields mean and standard deviation values in between of those for YUV666 801 and YUV 766 803.

Further, although the encoding method of the present invention has been described with reference to its application to video, one of ordinary skill in the art would appreciate that this method may also be employed for bandwidth efficient compression in other types of data such as graphics and still images.

Although described above in connection with particular embodiments of the present invention, it should be understood the descriptions of the embodiments are illustrative of the invention and are not intended to be limiting. Various modifications and applications may occur to those skilled in the art without departing from the true spirit and scope of the invention as defined in the appended claims.

We claim:

1. A method for compressing video data, the method comprising, for each pixel:
converting pixel data from a RGB color space to a YCbCr color space having Y, Cb, and Cr values;
quantizing the Y, Cb, and Cr values to generate a specified number of bits for each Y, Cb and Cr value;
rearranging and concatenating bits of quantized Y, Cb, and Cr values in Cb, Cr, Y format to create a word; and
creating a bitstream using data derived from said word.

2. The method of claim 1 wherein the step of creating a bitstream using data derived from said word comprises the steps of:
determining a first characteristic code value using the word;
determining a second characteristic code value using the first characteristic code value; and
concatenating said first and second characteristic code values to generate a coded bitstream.

3. The method of claim 2 wherein said first characteristic code value represents the difference between two successive words.

4. The method of claim 2 wherein said second characteristic code value represents the number of consecutive first characteristic code values having the same value.

5. The method of claim 3 further comprising the step of determining a first characteristic code value by classifying the first characteristic code value into a plurality of code length categories.

6. The method of claim 5 wherein the number of code length categories equals at least four.

7. The method of claim 6 wherein the code length categories are selected from the group consisting of 4 bits, 9 bits, 15 bits, and 21 bits.

8. The method of claim 5 further comprising the step of setting a value for a first set of bits in the first characteristic code value based on said determination step.

9. The method of claim 3 wherein the last bit of said first characteristic code value specifies the sign of the first characteristic code value.

10. A method for decoding compressed video data, the method comprising:
extracting first characteristic code values and second characteristic code values from a coded bitstream;
determining binary words representing pixels from the first and second characteristic code values extracted in the previous step;
rearranging the binary words from a Cb,Cr,Y format into a Y,Cb,Cr format;
subjecting the Y, Cb and Cr values for each word to inverse quantization; and
converting the inverse quantized Y, Cb and Cr values from a YCbCr color space into a RGB color space.

11. A system for compressing video data comprising:
a color converter for converting pixel data from a RGB color space to a YCbCr color space having Y, CB, and Cr values;
quantization elements for quantizing each of the Y, Cb, and Cr values to generate a specified number of bits for each Y, Cb and Cr value;
means for rearranging and concatenating the bits of quantized Y, Cb, and Cr values in Cb, Cr, Y format to create a word; and
means for generating a coded bitstream based upon said word.

12. The system of claim 11 further comprising a switch, which is configurable to select either a plurality of encoding techniques for compressing video data.

13. The system of claim 11 further comprising a means for generating a first characteristic code value wherein said first characteristic code value represents the difference between two successive words.

14. The system of claim 11 further comprising a means for generating a second characteristic code value wherein said second characteristic code value represents the number of consecutive first characteristic code values having the same value.
